(19) United States
(12) Patent Application Publication
(10) Pub. No.: US 2010/0038228 A1
(43) Pub. Date: Feb. 18, 2010

(54) Stand-Alone Circuit Breaker Assembly and Associated Method of Use

(75) Inventors: Etelvino L. Heres, St. Louis, MO (US); Gabriel Alvarez Del Prado, Mexico City (MX)

Correspondence Address: THOMPSON COBURN LLP, ONE US BANK PLAZA, SUITE 3500, ST LOUIS, MO, 63101, US

(73) Assignee: H-J INTERNATIONAL, INC., High Ridge, MO (US)

(21) Appl. No.: 12/189,917

(22) Filed: Aug. 12, 2008

(51) Int. Cl. H01H 35/26

(52) U.S. Cl. 200/81 R

(57) ABSTRACT

A stand-alone circuit breaker assembly that includes a housing having a plurality of openings, a plurality of first bushings mounted through the openings in the housing for receiving electrical power from the distribution transformer, at least one circuit breaker, each circuit breaker having a plurality of input terminals and a plurality of output terminals, wherein the at least one circuit breaker is located inside the housing, a plurality of first electrical connectors electrically connected in one-to-one correspondence between the plurality of first bushings and the plurality of input terminals, a plurality of second bushings mounted through the openings in the housing for providing electrical power through the at least one circuit breaker, and a plurality of second electrical connectors electrically connected in one-to-one correspondence between the plurality of second bushings and the plurality of output terminals. The stand-alone circuit breaker can be utilized with a distribution transformer.

### BACKGROUND OF INVENTION

Conventional distribution transformers used in electric power distribution, e.g., on power lines, have an internal, built-in circuit breaker in a single assembly to protect the distribution transformer in some cases. To retrofit a distribution transformer by adding an internal circuit breaker is costly, and requires disruption of power to the customer for an unacceptable length of time. Moreover, the cost of unprotected distribution transformer is significantly less than a distribution transformer that has a built-in circuit breaker.

Another problem occurs when a power surge hits a distribution transformer having an internal circuit breaker as a solitary unit; it may be so powerful that both the distribution transformer and circuit breaker are destroyed. This increases the time and cost of replacement. Also, in some cases, when one component goes bad, the entire combination unit of distribution transformer and circuit breaker must be replaced.

A known distribution transformer system that utilizes a separate circuit breaker is disclosed in U.S. Pat. No. 3,183,362, which was assigned to System Analyzer Corp. and issued on May 11, 1965. However, this distribution transformer also included a series of switching contacts that are housed within the distribution transformer. When this distribution transformer fails or blows-up, complex repairs are required. It is not a simple matter of replacing a distribution transformer since there are contacts located within the distribution transformer that are actuated by the circuit breaker. Therefore, the circuit breaker as well as the distribution transformer are not stand-alone, replaceable units. Moreover, this is a one-of-a kind distribution transformer which makes it very difficult to maintain and replace.

Therefore, a need exists in the art for a cost-effective solution that can be quickly installed to provide current overload protection for the distribution transformer with limited down-time to customers during installation. Also, a need exists for a low cost alternative to the expensive combination unit of distribution transformer and circuit breaker.

The present invention is directed to overcome one or more of the problems as set forth above.

### SUMMARY OF INVENTION

An aspect of the present invention includes a stand-alone circuit breaker in a box assembly that can quickly be installed immediately in series with an existing transformer, thereby providing suitable overload protection to the transformer. In use, the circuit breaker box assembly is mounted near the distribution transformer and connected in series between the transformer and the end-user (load) so that electricity flowing between the transformer and the end-user must pass through the circuit breaker box assembly. The circuit breaker assembly is directly connected to the transformer. When a current overload is detected, the circuit breaker will sever the connection to the end-user, thus protecting the transformer. When the problem has been corrected, the circuit breaker can be reset, restoring power to the end-user.

In one embodiment of the present invention, a single circuit breaker is provided that includes a circuit breaker mounted in a box, with the box having bushing assemblies installed thereto for wire connections. The circuit breaker may be implemented using a solenoid, a bimetallic strip, or both, as mere examples. The box is preferably sealable and at least partially filled with a non-conducting fluid such as mineral oil. The box may also include a fluid level sight gauge for viewing the level of the mineral oil or other fluid inside the box. The box may also include a fluid valve for conveniently filling or removing the fluid. Preferably, two sets of bushings are provided: one for the transformer side, and one for the load side. A circuit breaker is connected in series between the bushings so that current flowing between the transformer and the end-user must flow through the circuit breaker. When the circuit breaker allows electrical current to flow through, it is said to be in the closed position. When the circuit breaker does not allow current to flow through, it is said to be in the open or “tripped” position. In normal operation, the circuit breaker is in the closed position. If the current flowing through the circuit breaker is likely to cause the transformer to exceed acceptable parameters, the circuit breaker will trip and open the line, severing the electrical connection between the transformer and the load, thus preventing damage to the transformer. Once the circuit breaker has tripped, it activates an external trip signal such as a light, e.g., light-emitting diode (LED), mounted on the box. The trip signal serves to alert the technician to the fact that the circuit breaker inside the box has tripped, and must be reset to restore power to the end-user. The circuit breaker is externally resettable, i.e., it may be reset to a closed position without opening the box. The reset mechanism may be a mechanical handle that extends through an opening in the box that can be activated by using a hot-line stick.

Optionally, the box may include multiple circuit breakers, so that multiple loads may be independently connected to the transformer via the circuit breaker box assembly. In this embodiment, a unique set of bushings would be provided for connecting each circuit breaker to each individual load.

An aspect of the present invention includes a circuit breaker assembly. This circuit breaker assembly includes a housing having a plurality of openings, a plurality of first bushings mounted through the openings in the housing for receiving electrical power from a distribution transformer, a circuit breaker, having a plurality of input terminals and a plurality of output terminals, wherein the circuit breaker is located inside the housing, a plurality of first electrical connectors electrically connected in one-to-one correspondence between the plurality of first bushings and the plurality of input terminals, a plurality of second bushings mounted through the openings in the housing for providing electrical power from the circuit breaker, and a plurality of second electrical connectors electrically connected in one-to-one correspondence between the plurality of second bushings and the plurality of output terminals.

Another aspect of the present invention includes a circuit breaker assembly. This circuit breaker assembly includes a housing having a plurality of openings, a plurality of first bushings mounted through the openings in the housing for receiving electrical power from a distribution transformer, a plurality of circuit breakers, each having a plurality of input terminals and a plurality of output terminals, wherein the plurality of circuit breakers are located inside the housing, a plurality of first electrical connectors electrically connected in one-to-one correspondence between the plurality of first bushings and the plurality of input terminals, a plurality of second bushings mounted through the openings in the housing for providing electrical power through the plurality of circuit breakers, and a plurality of second electrical connectors electrically connected in one-to-one correspondence between the plurality of second bushings and the plurality of output terminals.

Still another aspect of the present invention includes an electrical power distribution system. This electrical power distribution system includes a distribution transformer, having a primary and a secondary, wherein the primary is capable of being electrically connected to a plurality of high voltage lines and the secondary includes a plurality of low voltage electrical conductors extending therefrom, a housing having a plurality of openings, a plurality of first bushings mounted through the openings in the container that are electrically connected to the plurality of low voltage electrical conductors, a plurality of circuit breakers, each having a plurality of input terminals and a plurality of output terminals, wherein the plurality of circuit breakers are located inside the housing, a plurality of first electrical connectors electrically connected in one-to-one correspondence between the plurality of first bushings and the plurality of input terminals, a plurality of second bushings mounted through the openings in the container for providing electrical power through the plurality of circuit breakers, and a plurality of second electrical connectors electrically connected in one-to-one correspondence between the plurality of second bushings and the plurality of output terminals.

Yet another aspect of the present invention includes a method of protecting a distribution transformer. This method includes mounting an external, stand-alone circuit breaker assembly in proximity to a distribution transformer, electrically connecting the stand-alone circuit breaker assembly to the distribution transformer in series, and electrically connecting the stand-alone circuit breaker assembly to an end-user such that an electrical path is created flowing from the distribution transformer, through the circuit breaker assembly to the end-user, wherein the stand-alone circuit breaker assembly includes a housing having a plurality of openings, a plurality of first bushings mounted through the openings in the housing for receiving electrical power from the distribution transformer, at least one circuit breaker, each circuit breaker having a plurality of input terminals and a plurality of output terminals, wherein the at least one circuit breaker is located inside the housing, a plurality of first electrical connectors electrically connected in one-to-one correspondence between the plurality of first bushings and the plurality of input terminals, a plurality of second bushings mounted through the openings in the housing for providing electrical power through the at least one circuit breaker, and a plurality of second electrical connectors electrically connected in one-to-one correspondence between the plurality of second bushings and the plurality of output terminals.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 illustrates a top-down view of an exemplary embodiment of the present invention utilizing a single circuit breaker shown with the lid removed;

FIG. 2 illustrates a side view of an exemplary embodiment of the present invention utilizing a single circuit breaker, as shown in FIG. 1;

FIG. 3 illustrates a second side view of an exemplary embodiment of the present invention utilizing a single circuit breaker, as shown in FIG. 1;

FIG. 4 illustrates a third side view of an exemplary embodiment of the present invention utilizing a single circuit breaker, as shown in FIG. 1;

FIG. 5 illustrates a top-down view of an alternative embodiment of the present invention utilizing a double circuit breaker shown with the lid removed;

FIG. 6 illustrates a side view of an alternative embodiment of the present invention utilizing a double circuit breaker, as shown in FIG. 5;

FIG. 7 illustrates a second side view of an alternative embodiment of the present invention utilizing a double circuit breaker, as shown in FIG. 5; and

FIG. 8 illustrates a third side view of an alternative embodiment of the present invention utilizing a double circuit breaker, as shown in FIG. 5.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. Additionally, the present invention contemplates that one or more of the various features of the present invention may be utilized alone or in combination with one or more of the other features of the present invention.

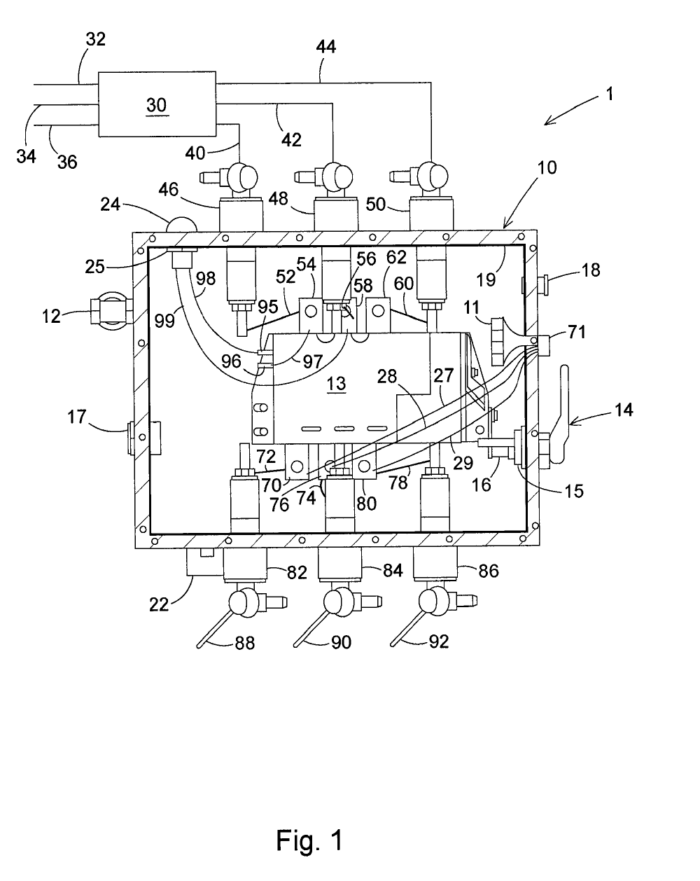

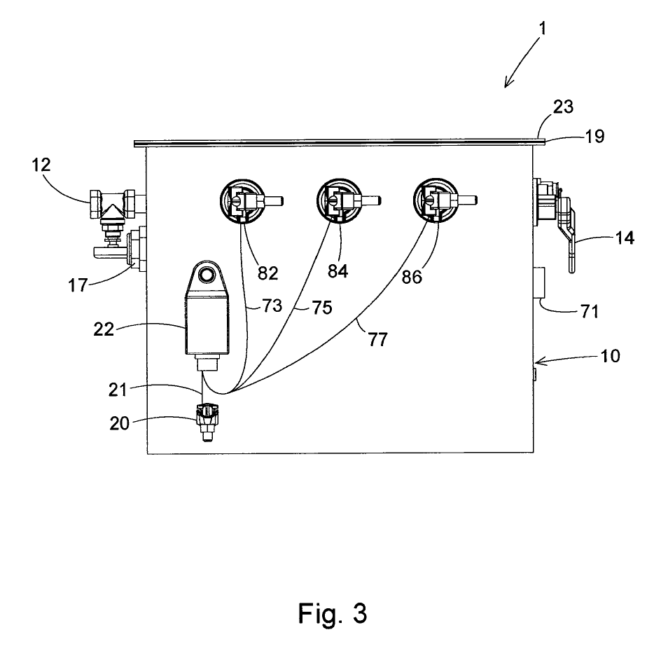

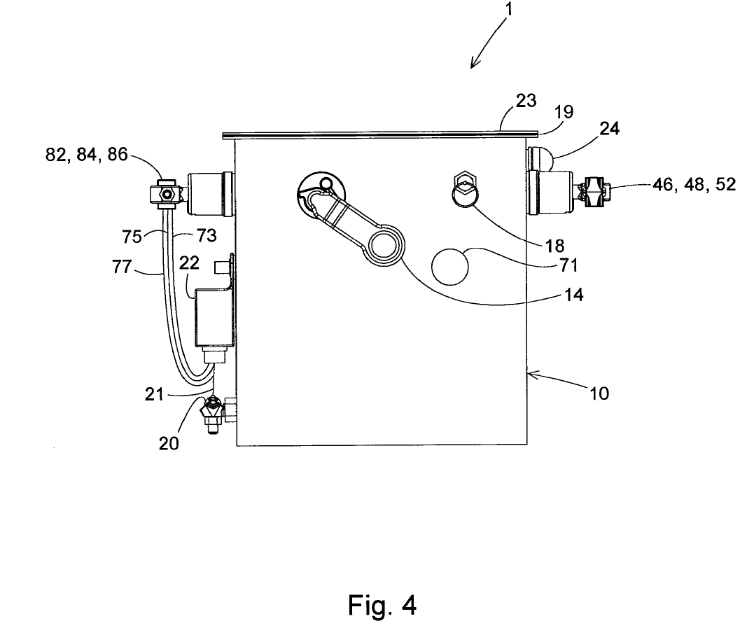

FIGS. 1-4 illustrate an exemplary embodiment of the present invention wherein the assembly contains a single circuit-breaker that is generally indicated by numeral 1. FIG. 1 shows a tank case 10 containing a circuit breaker 13. The tank case 10 can be any solid material, e.g., steel or hard plastic. The circuit breaker 13 includes a breaker handle 14 which extends through an opening in the tank case 10, allowing the circuit breaker 13 to be reset without opening the tank case 10 with a hot-line stick. There is an internally threaded handle nut 15 located inside the tank case 10 that receives an externally threaded cylindrical portion 16 of the breaker handle 14. A tank gasket 19 is fixedly attached to the tank case 10 and can include any material capable of forming a tight seal, e.g., rubber. There is a wide variety of circuit breakers that can be utilized with the present invention. Any of a wide variety of automatically-operated electrical switches designed to protect an electrical circuit from damage caused by overload or short circuit will suffice. There are magnetic circuit breakers that utilize a solenoid whose pulling force increases exponentially as the current increases. The circuit breaker's contacts are held closed by a latch and, as the current in the solenoid increases beyond the rating of the circuit breaker, the solenoid's pull releases the latch which then allows the contacts to open by spring action. There are thermal breakers that utilize a bimetallic strip, which heats and bends with increased current, and is similarly arranged to release the latch. There are also thermomagnetic circuit breakers that utilize both of the above techniques. The circuit breakers typically utilized for larger currents are usually arranged with pilot devices to sense a fault current and to operate the trip opening mechanism.

The tank case 10 is preferably filled with a non-conducting tank fluid, e.g., mineral oil. However, the tank case 10 does not absolutely need a non-conducting tank fluid and can simply be filled with air or vacuum. The tank fluid serves as a heat sink to prevent overheating of the device, and also provides arc-suppression to prevent arcing inside the tank. The tank fluid may also provide anti-corrosive benefits.

The tank case 10 includes a fluid valve 12 for filling or draining of the tank fluid from the tank case 10. The tank case 10 further includes a fluid level sight gauge 17 which allows the operator to view the fluid level in the tank case 10. The tank case 10 further includes a pressure release valve (PRV) 18 to expel non-conducting tank fluid from the tank case 10 in the event that the fluid pressure in the tank case 10 becomes too high.

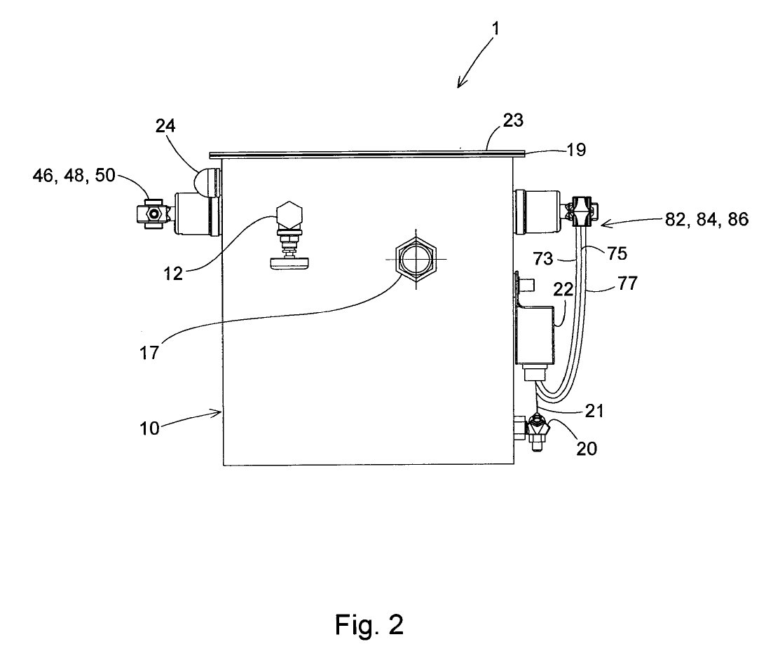

Referring now to FIGS. 2, 3 and 4, the tank case 10 further includes a ground lug 20, which can be any solid electrically conducting material. In use, the ground lug 20 is electrically connected to some type of ground wire connection (not shown).

Referring again to FIG. 1, there is a first high voltage line 32, a second high voltage line 34 and a third high voltage line 36, which are electrically connected to the primary of a standard, unprotected distribution transformer 30. From the secondary of the standard, unprotected distribution transformer 30 there is a first electrical, low voltage, output line 40, a second electrical, low voltage, output line 42 and a third electrical, low voltage, output line 44. The first electrical, low voltage, output line 40 is electrically connected to a first input bushing 46, the second electrical, low voltage, output line 42 is electrically connected to a second input bushing 48 and the third electrical, low voltage, output line 44 is electrically connected to a third input bushing 50. Although bushings are disclosed as the preferred embodiment, any of a wide variety of electrical connecting mechanisms will suffice.

There is a first electrical conductor 52 that is electrically connected to a first terminal 54 of the circuit breaker 13, a second electrical conductor 56 that is electrically connected to a second terminal 58 of the circuit breaker 13 and a third electrical conductor 60 that is electrically connected to a third terminal 62 of the circuit breaker 13.

On the output side of the circuit breaker 13, there is a fourth electrical conductor 72 that is electrically connected to a fourth terminal 70 of the circuit breaker 13, a fifth electrical conductor 74 that is electrically connected to a fifth terminal 76 of the circuit breaker 13 and a sixth electrical conductor 78 that is electrically connected to a sixth terminal 80 of the circuit breaker 13.

The fourth electrical conductor 72 is electrically connected to a first output bushing 82, the fifth electrical conductor 74 is electrically connected to a second output bushing 84 and the sixth electrical conductor 78 is electrically connected to a third output bushing 86. Electrically connected thereto and extending from the first output bushing 82, the second output bushing 84 and the third output bushing 86 are a first output line 88, a second output line 90 and third output line 92, respectively.

Referring again to FIGS. 2, 3 and 4, the tank case 10 further includes a lightning arrestor or surge protector 22, which is also shown in FIG. 1. The lightning arrestor 22 is electrically connected between at least two of the first output bushing 82 via a seventh conductor 73, the second output bushing 84 via an eighth conductor 75 and the third output bushing 86 via a ninth conductor 77. The lightning arrestor 22 is also electrically connected to ground lug 20 via a ground conductor 21. The lightning arrestor 22 protects equipment by diverting to ground any voltage surge above a predetermined value picked up from close lightning hits. For the lightning arrestor 22, there is no conductivity below the predetermined voltage and above the predetermined voltage; there is silicon oxide resistance in the lightning arrestor, which breaks down diverting current to ground within nanoseconds. Although the preferred wiring occurs outside of the tank case 10, it is possible to locate the seventh conductor 73, the eighth conductor 75, the ninth conductor 77 and the ground conductor 21 within the tank case 10.

Referring again to FIG. 1, a heater 11 can be optionally utilized in conjunction with a temperature controller 71, e.g., thermostat, to maintain oil temperature so the response time of the breaker is not influenced by fluctuations in ambient temperature. The temperature controller 71, e.g., thermostat, can be powered by a first temperature controller power conduit 27 that is electrically connected to the fourth terminal 70 of the circuit breaker 13, a second temperature controller power conduit 28 that is electrically connected to the fifth terminal 76 of the circuit breaker 13; and a third temperature controller power conduit 29 that is electrically connected to sixth terminal 80 of the circuit breaker 13.

An illustrative, but nonlimiting, example of an oil-filled transformer having a heater and thermostat for regulating temperature is found in U.S. Pat. No. 4,192,174, issued on Mar. 11, 1980 to Lobermann et al., which is incorporated herein by reference in its entirety.

As shown in FIG. 1, attached to the side of the tank case 10 is a signal light 24 that is secured by signal light nut 25. The signal light nut 25 is internally threaded to receive the externally threaded cylindrical end of the signal light 24. There is a first terminal 95 and a second terminal 96 that are electrically connected to the circuit breaker 13 that operate as a switch when the circuit breaker 13 is within a predetermined value of current over time. This electrical signal occurs when an overload situation is imminent. The signal light 24 is connected to the first terminal 95 through a first signal connector 98 while the second terminal 96 is connected to the first terminal 54 of the circuit breaker 13 via a second signal connector 97. There is a third signal connector 99 that is connected between the signal light 24 and the second terminal 58 of the circuit breaker 13. A small transformer (not shown) may be utilized to decrease the voltage between the signal light 24 and the first terminal 95. Preferably, a circuit breaker 13, e.g., bimetal circuit-breaker, is utilized that can provide a signal to the signal light 24 in an overload situation prior to the circuit breaker 13 being tripped. Once the circuit breaker 13 is tripped, a breaker handle 14 which extends through an opening in the tank case 10 allows the circuit breaker 13 to be reset without opening the tank case 10.

FIGS. 2, 3 and 4 illustrate the tank case 10 with a tank lid 23 attached. The tank lid 23 can be any solid material, e.g., steel or hard plastic. The tank gasket 19 fits between tank case 10 and the tank lid 23 providing a tight seal.

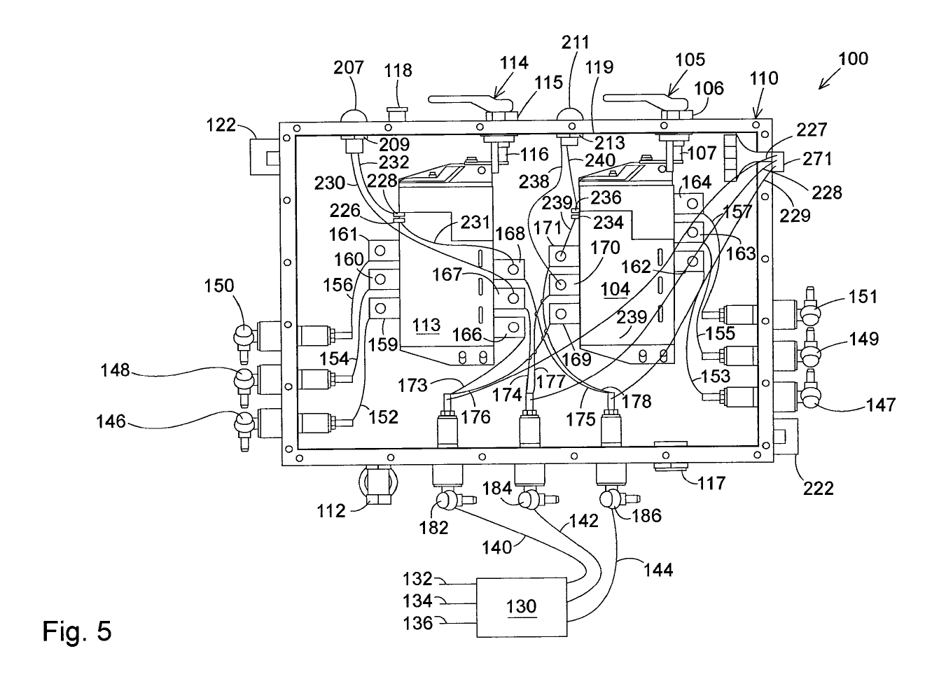

A first alternative embodiment of a dual circuit breaker system, as shown in FIGS. 5-8, is generally indicated by numeral 100. FIG. 5 shows a tank case 110 containing a first circuit breaker 113. The tank case 110 can be any solid material, e.g. steel or hard plastic. There is a first circuit breaker 113 that includes a first breaker handle 114 which extends through an opening in the tank case 110, allowing the first circuit breaker 113 to be reset without opening the tank case 110. Also, there is a second circuit breaker 104 that includes a second breaker handle 105 which also extends through an opening in the tank case 110, allowing the second circuit breaker 104 to be reset without opening the tank case 110. There is a first internally threaded handle nut 115 located inside the tank case 110 that receives a first externally threaded cylindrical portion 116 of the first breaker handle 114 and a second internally threaded handle nut 106 located inside the tank case 110 that receives a second externally threaded cylindrical portion 107 of the second breaker handle 105. A tank gasket 119 is fixedly attached to the tank case 110 and can include any material capable of forming a tight seal, e.g., rubber.

The tank case 110 is preferably filled with a non-conducting tank fluid, e.g., mineral oil. However, the tank case 110 does not absolutely need a non-conducting tank fluid and can simply be filled with air or vacuum. The tank fluid serves as a heat sink to prevent overheating of the device, and also provides arc-suppression to prevent arcing inside the tank case 110. The tank fluid may also provide anti-corrosive benefits.

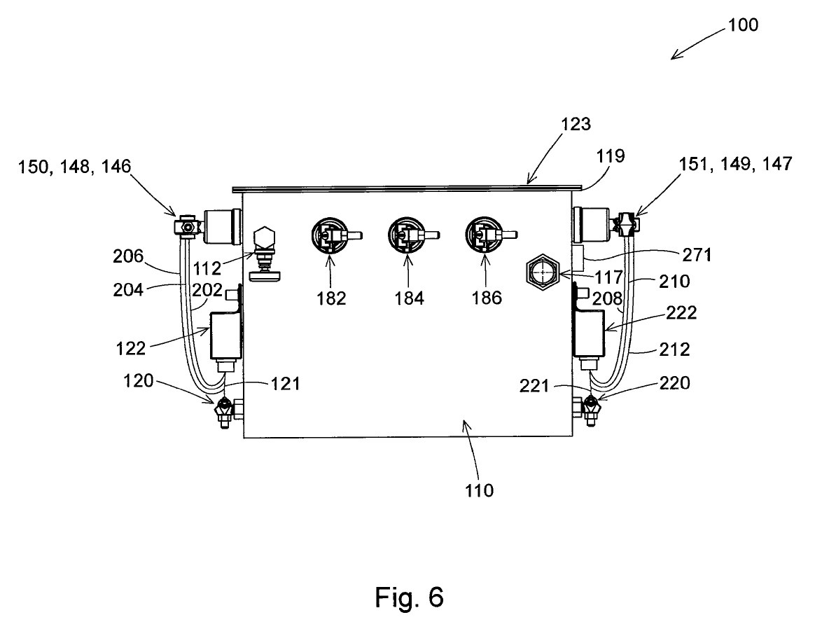

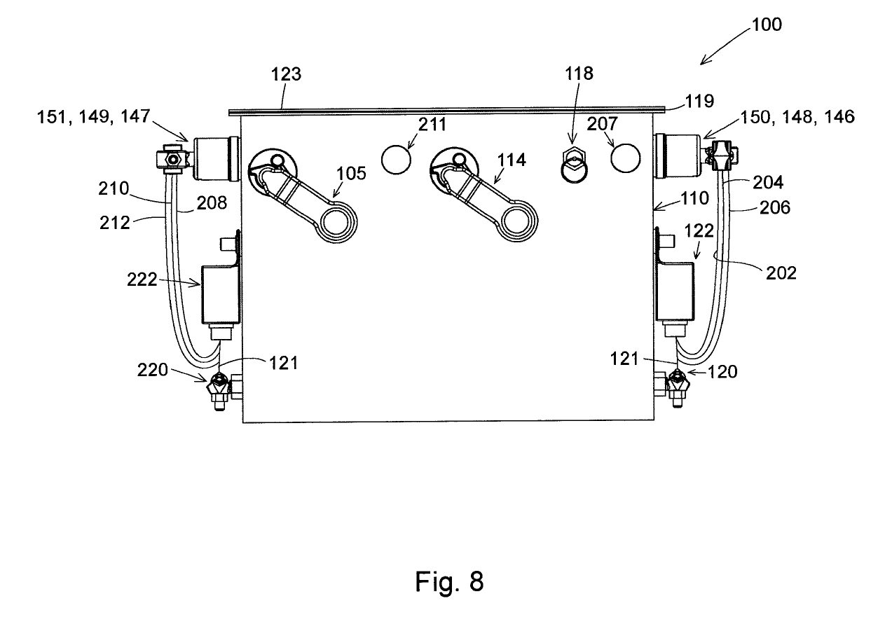

As shown in FIGS. 5 and 6, the tank case 110 includes a fluid valve 112 for filling or draining of the tank fluid from the tank case 110. The tank case 110 further includes a fluid level sight gauge 117 which allows the operator to view the fluid level in the tank case 110. As shown in FIGS. 5 and 8, the tank case 110 further includes a pressure release valve (PRV) 118 to expel non-conducting tank fluid from the tank case 110 in the event that the fluid pressure in the tank case 110 becomes too high.

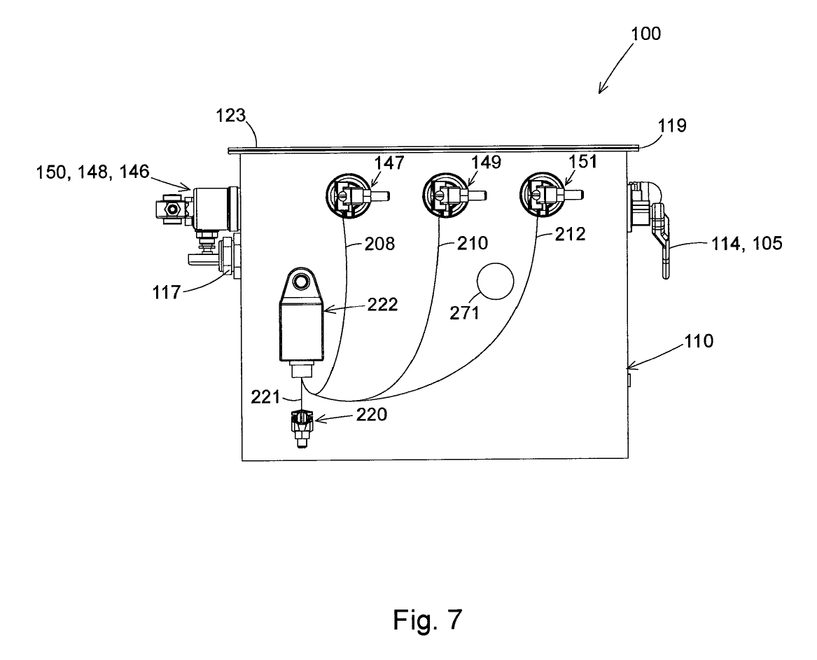

Referring now to FIGS. 6 and 8, the tank case 110 further includes a first ground lug 120, which can be any solid electrically conducting material. In use, the first ground lug 120 is electrically connected to some type of ground wire connection (not shown). Also, the tank case 110 further includes a second ground lug 220, also shown in FIG. 7, which can be any solid electrically conducting material. In use, the first ground lug 220 is electrically connected to some type of ground wire connection (not shown).

Referring again to FIG. 5, there is a first high voltage line 132, a second high voltage line 134 and a third high voltage line 136, which are electrically connected to the primary of a standard, unprotected distribution transformer 130. From the secondary of the standard, unprotected distribution transformer 130 there is a first electrical line 140 that is electrically connected to a first input bushing 182, a second electrical line 142 that is electrically connected to a second input bushing 184, and a third electrical line 144 that is electrically connected to a third input bushing 186.

On the input side of a first circuit breaker 113, there is a first electrical conductor 173 that is electrically connected to a first terminal 166 of the first circuit breaker 113, a second electrical conductor 174 that is electrically connected to a second terminal 167 of the first circuit breaker 113 and a third electrical conductor 175 that is electrically connected to a third terminal 168 of the first circuit breaker 113.

On the input side of a second circuit breaker 104, there is a fourth electrical conductor 176 that is electrically connected to a fourth terminal 169 of the second circuit breaker 104, a fifth electrical conductor 177 that is electrically connected to a fifth terminal 170 of the second circuit breaker 104 and a sixth electrical conductor 178 that is electrically connected to a sixth terminal 171 of the second circuit breaker 104.

On the output side of the first circuit breaker 113, there is a seventh electrical conductor 156 that is electrically connected to a fourth terminal 161 of the first circuit breaker 113, an eighth electrical conductor 154 that is electrically connected to a fifth terminal 160 of the first circuit breaker 113 and a ninth electrical conductor 152 that is electrically connected to a sixth terminal 159 of the first circuit breaker 113. The seventh electrical conductor 156 is electrically connected to a first output bushing 150, the eighth electrical conductor 154 is electrically connected to a second output bushing 148, and the ninth electrical conductor 152 is electrically connected to a third output bushing 146.

On the output side of the second circuit breaker 104, there is a tenth electrical conductor 157 that is electrically connected to a fourth terminal 164 of the second circuit breaker 104, an eleventh electrical conductor 155 that is electrically connected to a fifth terminal 163 of the second circuit breaker 104 and a twelfth electrical conductor 153 that is electrically connected to a sixth terminal 162 of the second circuit breaker 104. The tenth electrical conductor 157 is electrically connected to a fourth output bushing 151, the eleventh electrical conductor 155 is electrically connected to a fifth output bushing 149, and the twelfth electrical conductor 153 is electrically connected to a sixth output bushing 147.

As shown in FIGS. 6 and 8, the tank case 110 further includes a first lightning arrestor or surge protector 122. The first lightning arrestor 122 is also electrically connected to a first ground lug 120 via a first ground conductor 121. The first lightning arrestor 122 protects equipment by diverting to ground any voltage surge above a predetermined value picked up from close lightning hits. For the first lightning arrestor 122, there is no conductivity below the predetermined voltage and above the predetermined voltage; there is silicon oxide resistance in the lightning arrestor, which breaks down diverting current to ground within nanoseconds. The first lightning arrestor 122 is electrically connected to the first output bushing 150 via a thirteenth electrical conductor 202, the second output bushing 148 via a fourteenth electrical conductor 204, and the third output bushing 146 via a fifteenth electrical conductor 206. Although the preferred wiring occurs outside of the tank case 110, it is possible to locate the thirteenth electrical conductor 202, the fourteenth electrical conductor 204, the fifteenth electrical conductor 206, and the first ground conductor 121 within the tank case 110.

As shown in FIGS. 5-8, the tank case 110 further includes a second lightning arrestor or surge protector 222. The second arrestor 222 is also electrically connected to a second ground lug 220 via a second ground conductor 221. The second lightning arrestor 222 protects equipment by diverting to ground any voltage surge above a predetermined value picked up from close lightning hits. For the second lightning arrestor 222, there is no conductivity below the predetermined voltage and above the predetermined voltage; there is silicon oxide resistance in the lightning arrestor, which breaks down diverting current to ground within nanoseconds. The second lightning arrestor 222 is electrically connected to the fourth output bushing 151 via an sixteenth electrical conductor 212, the fifth output bushing 149 via a seventeenth electrical conductor 210, and the sixth output bushing 147 via a eighteenth electrical conductor 208. Although the preferred wiring occurs outside of the tank case 110, it is possible to locate the sixteenth electrical conductor 212, the seventeenth electrical conductor 210, and the eighteenth electrical conductor 208. and the second ground conductor 221 within the tank case 110.

Referring again to FIG. 5, a heater 111 can be optionally utilized in conjunction with a temperature controller 271, e.g., thermostat, can be used to maintain oil temperature so the response time of the breaker is not influenced by fluctuations in ambient temperature. The temperature controller 271, e.g., thermostat, can be powered by a first temperature controller power conduit 227 that is electrically connected to the first output bushing 182; a second temperature controller power conduit 228 that is electrically connected to the second output bushing 184; and a third temperature controller power conduit 229 that is electrically connected to the third output bushing 186.

Optionally, a heater 111, utilized in conjunction with a temperature controller 271, e.g., thermostat, can be used to maintain oil temperature so the response time of the breaker is not influenced by fluctuations in ambient temperature. An illustrative, but nonlimiting, example of an oil-filled transformer having a heater and thermostat for regulating temperature is found in U.S. Pat. No. 4,192,174, issued on Mar. 11, 1980 to Lobermann et al., which is incorporated herein by reference in its entirety.

As shown in FIG. 5, attached to the side of the tank case 110 is a first signal light 207 that is secured by first signal light nut 209. The first signal light nut 209 is internally threaded to receive the externally threaded cylindrical end of the first signal light 207 that is electrically connected via a first signal conductor 232 to the first terminal 228 of the first circuit breaker 113. There is a second terminal 226 of the first circuit breaker 113 that is electrically connected to the third terminal 168 of the first circuit breaker 113 via a second signal conductor 231 . The first signal light 207 is also connected to the second terminal 167 of the first circuit breaker 113 via a third signal conductor 230. The first terminal 228 and the second terminal 226 are electrically connected to the first circuit breaker 113 and operate as a switch when the first circuit breaker 113 is within a predetermined value of current over time. This electrical signal occurs when an overload situation is imminent.

Also shown in FIG. 5, attached to the side of the tank case 110 is a second signal light 211 that is secured by second signal light nut 213. The second signal light nut 211 is internally threaded to receive the externally threaded cylindrical end of the second signal light 211 that is electrically connected via a fourth signal conductor 240 to the first terminal 236 of the second circuit breaker 104. There is a second terminal 234 of the second circuit breaker 104 that is electrically connected to the sixth terminal 171 of the second circuit breaker 104 via a fifth signal conductor 239. The second signal light 211 is also connected to the fifth terminal 170 of the second circuit breaker 104 via a sixth signal conductor 238. The first terminal 236 and the second terminal 234 are electrically connected to the second circuit breaker 104 and operate as a switch when the second circuit breaker 104 is within a predetermined value of current over time. This electrical signal occurs when an overload situation is imminent.

FIGS. 6, 7 and 8 illustrate the tank case 110 with a tank lid 123 attached. The tank lid 123 can be any solid material, e.g., steel or hard plastic. The tank gasket 119 fits between tank case 110 and the tank lid 123 providing a tight seal.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “have,” “having,” “includes,” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims that follow.

1. A circuit breaker assembly comprising:
a housing having a plurality of openings;
a plurality of first bushings mounted through the openings in the housing for receiving electrical power from a distribution transformer;
a circuit breaker, having a plurality of input terminals and a plurality of output terminals, wherein the circuit breaker is located inside the housing;
a plurality of first electrical connectors electrically connected in one-to-one correspondence between the plurality of first bushings and the plurality of input terminals;
a plurality of second bushings mounted through the openings in the housing for providing electrical power from the circuit breaker; and
a plurality of second electrical connectors electrically connected in one-to-one correspondence between the plurality of second bushings and the plurality of output terminals.

2. The circuit breaker assembly of claim 1, wherein the housing is a sealable tank that is capable of being at least partially filled with a non-conducting fluid.

3. The circuit breaker assembly of claim 1, further includes at least one lightning arrestor that is electrically connected between the at least one of the plurality of output terminals and ground.

4. The circuit breaker assembly of claim 2, further includes a fluid level sight gauge mounted on a side of the sealable tank.

5. The circuit breaker assembly of claim 2, further includes a fluid valve mounted on a side of the sealable tank.

6. The circuit breaker assembly of claim 2, further includes a pressure relief valve mounted on a side of the sealable tank.

7. The circuit breaker assembly of claim 1, wherein the circuit breaker is selected from the group consisting of a solenoid-type circuit breaker, a bimetallic strip-type circuit breaker or a relay-type circuit breaker.

8. The circuit breaker assembly of claim 1, further includes a light that is electrically connected to the circuit breaker that operates when current applied to the circuit breaker is within a predetermined current over time that indicates an overload situation.

9. The circuit breaker assembly of claim 2, further includes a heater that is electrically connected to a temperature controller.

10. The circuit breaker assembly of claim 9, wherein the temperature controller includes a thermostat.

11. A circuit breaker assembly comprising:
a housing having a plurality of openings;
a plurality of first bushings mounted through the openings in the housing for receiving electrical power from a distribution transformer;
a plurality of circuit breakers, each having a plurality of input terminals and a plurality of output terminals, wherein the plurality of circuit breakers are located inside the housing;
a plurality of first electrical connectors electrically connected in one-to-one correspondence between the plurality of first bushings and the plurality of input terminals;
a plurality of second bushings mounted through the openings in the housing for providing electrical power through the plurality of circuit breakers; and
a plurality of second electrical connectors electrically connected in one-to-one correspondence between the plurality of second bushings and the plurality of output terminals.

12. The circuit breaker assembly of claim 11, wherein the housing is a sealable tank that is capable of being at least partially filled with a non-conducting fluid.

13. The circuit breaker assembly of claim 11, further includes at least one lightning arrestor that is electrically connected between at least one of the plurality of output terminals and ground.

14. The circuit breaker assembly of claim 12, further includes a fluid level sight gauge mounted on a side of the sealable tank, a fluid valve mounted on a side of the sealable tank and a pressure relief valve mounted on a side of the sealable tank.

15. The circuit breaker assembly of claim 11, wherein the plurality of circuit breakers are selected from the group consisting of a solenoid- type circuit breaker, a bimetallic strip-type circuit breaker or a relay-type circuit breaker.

16. The circuit breaker assembly of claim 11, further includes a plurality of lights that are each electrically connected to the plurality of circuit breakers that operate when current applied to a circuit breaker of the plurality of circuit breakers is within a predetermined current over time that indicated an overload situation.

17. The circuit breaker assembly of claim 12, further includes a heater that is electrically connected to a temperature controller.

18. The circuit breaker assembly of claim 17, wherein the temperature controller includes a thermostat.

19. An electrical power distribution system comprising:
a distribution transformer, having a primary and a secondary, wherein the primary is capable of being electrically connected to a plurality of high voltage lines and the secondary includes a plurality of low voltage electrical conductors extending therefrom;
a housing having a plurality of openings;
a plurality of first bushings mounted through the openings in the container that are electrically connected to the plurality of low voltage electrical conductors;
a plurality of circuit breakers, each having a plurality of input terminals and a plurality of output terminals, wherein the plurality of circuit breakers are located inside the housing;
a plurality of first electrical connectors electrically connected in one-to-one correspondence between the plurality of first bushings and the plurality of input terminals;
a plurality of second bushings mounted through the openings in the container for providing electrical power through the plurality of circuit breakers; and
a plurality of second electrical connectors electrically connected in one-to-one correspondence between the plurality of second bushings and the plurality of output terminals.

20. The electrical power distribution system of claim 19, wherein the housing is a sealable tank that is capable of being at least partially filled with a non-conducting fluid and includes a removable panel and a gasket for sealing the panel to the sealable tank.

21. The circuit breaker assembly of claim 19, further includes at least one lightning arrestor that is electrically connected between at least one of the plurality of input terminals and at least one of the plurality of output terminals.

22. The circuit breaker assembly of claim 19, further includes a fluid level sight gauge mounted on a side of the sealable tank, a fluid valve mounted on a side of the sealable tank and a pressure relief valve mounted on a side of the sealable tank.

23. The circuit breaker assembly of claim 19, further includes a heater that is electrically connected to a temperature controller.

24. The circuit breaker assembly of claim 23, wherein the temperature controller includes a thermostat.

25. A method of protecting a distribution transformer comprising:
mounting an external, stand-alone circuit breaker assembly in proximity to a distribution transformer;
electrically connecting the stand-alone circuit breaker assembly to the distribution transformer in series; and
electrically connecting the stand-alone circuit breaker assembly to an end-user such that an electrical path is created flowing from the distribution transformer, through the circuit breaker assembly to the end-user, wherein the stand-alone circuit breaker assembly includes a housing having a plurality of openings, a plurality of first bushings mounted through the openings in the housing for receiving electrical power from the distribution transformer, at least one circuit breaker, each circuit breaker having a plurality of input terminals and a plurality of output terminals, wherein the at least one circuit breaker is located inside the housing, a plurality of first electrical connectors electrically connected in one-to-one correspondence between the plurality of first bushings and the plurality of input terminals, a plurality of second bushings mounted through the openings in the housing for providing electrical power through the at least one circuit breaker, and a plurality of second electrical connectors electrically connected in one-to-one correspondence between the plurality of second bushings and the plurality of output terminals.
